(19) United States
(12) Patent Application Publication
(10) Pub. No.: US 2009/0303590 A1
(43) Pub. Date: Dec. 10, 2009

(54) OPTICAL FILTER AND IMAGING APPARATUS

(75) Inventor: Yoshiaki Irie, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/478,269

(22) Filed: Jun. 4, 2009

(30) Foreign Application Priority Data
Jun. 6, 2008 (JP) 2008-149637

(51) Int. Cl. G02B 5/30

(52) U.S. Cl. 359/490; 250/200

(57) ABSTRACT

An optical filter that is disposed in front of an image sensor. The optical filter includes a first optical member, and a second optical member that is disposed closer to the image sensor than the first optical member. An anti-reflection multilayer film is formed on an incident surface of the first optical member. A film which is made of a material containing fluorine is formed on an outermost layer of the anti-reflection multilayer film. A dichroic multilayer film is formed between a light-emitting surface of the first optical member and an incident surface of the second optical member.

### BACKGROUND OF THE INVENTION

1. Field of the Invention

The present invention relates to an imaging apparatus and an optical filter that is disposed between a photographic lens and an image sensor, attenuates a high frequency component of luminous flux guided to the image sensor, and is suitable for cutting an infrared component of the luminous flux.

2. Description of the Related Art

An optical filter which includes a low-pass filter and an infrared absorption filter is disposed in front of an image sensor in a conventional imaging apparatus such as a digital camera. The low-pass filter suppresses generation of a false color that is caused by a pseudo signal of an object image in an image sensor configured of a charge coupled device (CCD), or complementary metal oxide semiconductor (CMOS). The infrared absorption filter makes a sensitivity of the image sensor approximate to a sensitivity of a human eye.

Since the front surface of the optical filter is exposed to the air, foreign substances, such as dust floating in the air and generated in the camera, are inevitably attached to the front surface of the optical filter. As a result, an image of foreign substances is captured together with an object image, so that an image quality is deteriorated.

The following methods are effective in preventing attachment of foreign substances to the optical filter or in removing foreign substances attached to the optical filter.
(1) A method for applying vibration to the optical filter so that foreign substances are shaken off.
(2) A method for removing static electricity of the optical filter so that the attachment of foreign substances is prevented.
(3) A method for coating the surface of the optical filter so that foreign substances are hardly attached to the optical filter.

As for the method (1) which shakes off foreign substances attached to an optical low-pass filter, Japanese Patent Application Laid-Open No. 2007-134801 discusses a technique in which an optical low-pass filter is disposed adhering to a piezoelectric element to follow the expansion and contraction of the piezoelectric element.

As for the method (2) which prevents electrostatic charges from accumulating on an optical filter, Japanese Patent Application Laid-Open No. 2005-148379 discusses a technique in which at least one layer placed second or more from a surface of an anti-reflection (AR) film of an optical filter is formed of a conductive film such as indium tin oxide (ITO). Japanese Patent Application Laid-Open No. 2007-193264 also discusses a technique in which an ITO film is formed to increase conductivity of a surface of a coated layer.

As for the method (3) which coats a surface of an optical filter so that foreign substances are hardly attached to the optical filter, Japanese Patent Application Laid-Open No. 2006-163275 discusses a technique in which a coat is formed of magnesium fluoride (MgF₂) or a high molecular material containing fluorine. Accordingly, surface energy of the optical filter may decrease and foreign substances may be easily removed by an air blower.

Generally, an array of the color filter that corresponds to pixels of an image sensor is based on a Bayer array formed of four RGBG pixels. When one spot beam enters the optical low-pass filter, the generation of a false color on a captured image is suppressed by performing 4-spot image separation in which one spot beam is separated into four spot beams.

FIG. 14 illustrates a configuration of a general optical filter which is formed by bonding four optical members together to perform 4-spot image separation. A birefringent crystal plate 300 is made of a birefringent material such as crystal, and a birefringent crystal plate which has a rotation angle of 0° to perform 2-spot separation in a horizontal direction is used for the crystal plate 300. An infrared absorption filter 301 substantially matches a spectral sensitivity of an image sensor such as a CCD to a sensitivity of a human eye. A depolarization plate (λ/4 wavelength plate) 302 made of crystal depolarizes object luminous flux linearly polarized by passing through the birefringent crystal plate 300. A birefringent crystal plate 303 has a rotation angle of 90°. If the object luminous flux passes through the birefringent crystal plate 303, spot image separation is performed in a vertical direction. The object luminous flux which passes through the optical filter with the above described configuration and is separated to four spots, finally enters an image sensor 106. Accordingly, the generation of the false color of the captured image is suppressed. A cover glass 309 seals a light-receiving part 106a of the image sensor 106 within a package 106b.

Generally, about forty layers of ultraviolet (UV)-infrared (IR) rays cutting coats 401 are formed on the surface of the birefringent crystal plate 300 facing the photographic lens side, and desired spectral transmissivity of light entering the image sensor 106 can be obtained by an interaction with the wavelength absorption characteristic of the infrared absorption filter 301. In addition, an AR coat 402 for anti-reflection is formed on the surface of the birefringent crystal plate 303 facing the image sensor side and both surfaces of the cover glass 309 to reduce reflected light at an interface of each medium on an object light path.

Since a large number of layers of the UV-IR cutting coat 401 are formed, timing to remove unnecessary deposition materials attached to an inner wall of a deposition device is very important to maintain optical performance and production efficiency. Deposition materials, such as SiO₂ and TiO₂, are commonly used in the UV-IR cutting coat and the AR coat. However, since a fluorine-based material is a resin, these two deposition materials are greatly different in deposition conditions, such as a substrate temperature of a deposition object and a heating temperature of the deposition material. Therefore, performing deposition of these deposition materials in one process is difficult in terms of production efficiency. Further, after the fluorine-based material is deposited, the inner wall needs to be cleaned more frequently than usual so that the material attached to the inner wall of the deposition device does not affect later deposition. If the inner wall is not frequently cleaned, the remained fluorine-based material may contaminate the deposition materials such as SiO₂ and TiO₂. As a result, it may cause performance deterioration, such as increase of haze, abnormality of spectrum, and increase of defects. Further, the frequent cleaning is directly connected to increase of a manufacturing cost of the low-pass filter.

Meanwhile, to prevent the attachment of foreign substances due to static electricity, a transparent conductive film (indium tin oxide (ITO) film) may be formed on an optical base material so that electrostatic charges do not accumulate on the optical filter. However, when the transparent conductive film is deposited by a vacuum deposition device that is a general device for depositing an optical thin film, the deposition device needs to satisfy requirements, such as forming an oxygen atmosphere in a chamber. For this reason, the transparent conductive film is generally deposited by a sputtering method, and a deposition device dedicated to the deposition of the transparent conductive film needs to be provided in the process.

Accordingly, there has been a demand for a deposited film which is formed on a surface of an optical filter facing a photographic lens side and does not accumulate electrostatic charges without using a transparent conductive film, and further, a demand for a deposited film which enables manufacture of an optical filter which may suppress attachment of foreign substances by forming a foreign substance-attachment preventing film on an outermost layer thereof, with high quality and low cost.

### SUMMARY OF THE INVENTION

According to an aspect of the present invention, an optical filter that is disposed in front of an image sensor, includes a first optical member, and a second optical member that is disposed closer to the image sensor than the first optical member, wherein an anti-reflection multilayer film is formed on an incident surface of the first optical member, a film which is made of a material containing fluorine is formed on an outermost layer of the anti-reflection multilayer film, and a dichroic multilayer film is formed between a light-emitting surface of the first optical member and an incident surface of the second optical member.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a schematic configuration of a digital single-lens reflex camera according to a first exemplary embodiment.

FIG. 2 is an electrical block diagram illustrating the schematic configuration of the digital single-lens reflex camera according to the first exemplary embodiment.

FIG. 3 is a flowchart illustrating an operation of the digital single-lens reflex camera according to the first exemplary embodiment.

FIG. 4 is an enlarged cross-sectional view of a peripheral portion of an image sensor and an optical filter of the first exemplary embodiment.

FIG. 5 is an enlarged view schematically illustrating a shape of a first optical member of the first exemplary embodiment in a thickness direction.

FIG. 6 is enlarged SEM photographs illustrating cross-section of a UV-IR multilayer film that is deposited on a crystal substrate.

FIG. 7 illustrates a summary of a charging experiment.

FIG. 8 illustrates a ghost light path in the image sensor and the optical filter of the first exemplary embodiment.

FIG. 9 illustrates characteristic curves of spectral transmissivity of each optical element.

FIG. 10 is an enlarged cross-sectional view of a peripheral portion of an image sensor and an optical filter of a second exemplary embodiment.

FIG. 11 is an enlarged cross-sectional view of a peripheral portion of an image sensor and an optical filter of a third exemplary embodiment.

FIG. 12 is an enlarged cross-sectional view of a peripheral portion of an image sensor and an optical filter of a fourth exemplary embodiment.

FIG. 13 is an enlarged cross-sectional view of a peripheral portion of an image sensor and an optical filter of a fifth exemplary embodiment.

FIG. 14 illustrates a configuration example of an optical filter.

### DETAILED DESCRIPTION OF THE EMBODIMENTS

Various exemplary embodiments, features, and aspects of the invention will be described in detail below with reference to the drawings.

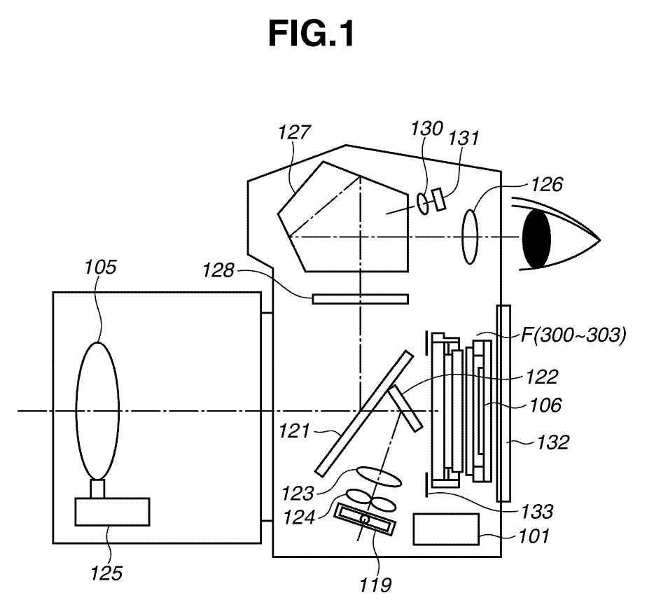

FIG. 1 illustrates schematic configuration of a digital single-lens reflex camera (hereinafter, referred to as a “digital camera”) according to a first exemplary embodiment of the invention. In FIG. 1, a central processing unit (CPU) 101 controls an operation of the digital camera.

A photographic lens 105 forms an image on an image sensor 106 by focusing a photographic object light. The photographic lens 105 is built in a lens unit that is detachably attached to a body of the digital camera. The image sensor 106 is an image sensor that is typified by a CCD. A focal plane shutter 133 controls an amount of the photographic object light that reaches the image sensor 106 from the photographic lens 105.

A part of the photographic object light is guided to a known phase-difference type focus detection unit by a semi-transparent main mirror 121 and a sub-mirror 122. Accordingly, which direction and how much the object light formed as the image by the photographic lens 105 is out of focus on a light-receiving surface of the image sensor 106, can be detected as a defocus amount. The phase-difference type focus detection unit includes a field lens 123, a secondary image forming lens 124, and a CCD line sensor 119 for focus detection. The phase-difference type focus detection unit can detects the focuses of fifteen areas that are disposed in a form of a 3×5 matrix or in any combination thereof in vertical and horizontal directions on a finder screen.

A photographic lens driving unit 125 is provided in the lens unit. The CPU 101 sends a driving quantity pulse for driving the photographic lens 105 to the photographic lens driving unit 125, in consideration of a lens drive sensitivity (fineness of control unique to the lens) of the photographic lens 105 according to the obtained defocus amount. The photographic lens driving unit 125 drives a pulse motor according to the sent pulse and drives the photographic lens 105 to a focusing position to perform automatic focus adjustment.

The digital camera includes an eyepiece lens 126, a pentagonal prism 127 that is an optical reversing unit for reversing an image, and a focusing plate 128 that is placed on an image formation surface of the photographic lens 105 equivalent to the image formation surface of the image sensor 106. The object light which passes through the photographic lens 105 is reflected by the semi-transparent main mirror 121 and forms an image on the focusing plate 128. Accordingly, a through the lens (TTL) optical finder is formed by which a photographer/user can see an object image formed on the focusing plate 128 through the pentagonal prism 127 and the eyepiece lens 126.

The digital camera includes an image forming lens 130 and a light metering sensor 131 that measures brightness of a visible light of the photographic object. The object image which is formed on the focusing plate 128 is secondarily formed on the light metering sensor 131 by the image forming lens 130. The light metering sensor 131 has a light-receiving area that is divided into the form of the 3×5 matrix in the vertical and horizontal directions, and divides a main area of a field of the finder (object area) into areas that has the form of the 3×5 matrix.

An optical filter F is disposed between the photographic lens 105 and the image sensor 106, attenuates a high frequency component of the luminous flux that is guided to the image sensor 106, and cuts an infrared component of the luminous flux. The optical filter F includes a plurality of optical members 300 to 303 as described below. A birefringent crystal plate 300 which is disposed on the photographic lens 105 side removes foreign substances such as dust attached to the surface thereof by vibration that is applied from the outside.

An external display unit 132 is formed of thin film transistor (TFT) color liquid crystal.

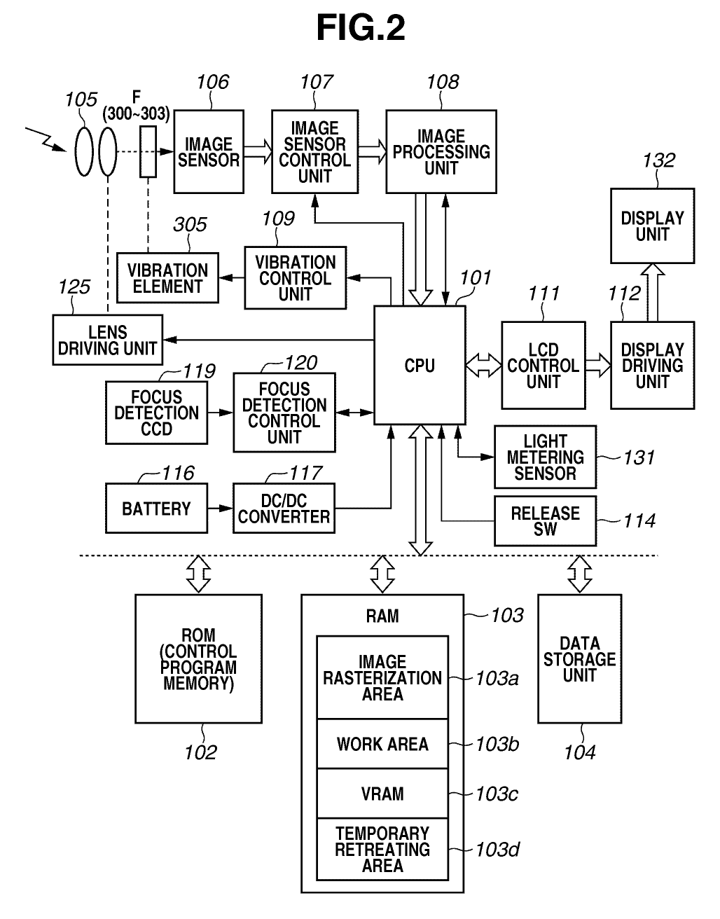

If the photographer/user presses a release SW 114 (see FIG. 2), the semi-transparent main mirror 121 retreats to the outside of a light path of the photographic lens 105 and the focal plane shutter 133 controls the amount of the object light condensed by the photographic lens 105. Further, after the light is photoelectrically converted into an object image by the image sensor 106, the object image is recorded on a recording medium such as a flash memory as image data. Meanwhile, the object image is displayed on the display unit 132 as an image that has been captured.

FIG. 2 is an electrical block diagram illustrating the schematic configuration of the digital camera according to the first exemplary embodiment, and the same elements as those illustrated in FIG. 1 are denoted by the same reference numerals. A read-only memory (ROM) 102 in which a control program is stored, a random access memory (RAM) 103, a data storage unit 104, an image processing unit 108, a vibration control unit 109, a liquid crystal display (LCD) control unit 111, the release SW 114, a direct current/direct current (DC/DC) converter 117, a focus detection control unit 120, the photographic lens driving unit 125, and the light metering sensor 131 are connected to the CPU 101.

In one embodiment,an image sensor control unit 107 and the image sensor 106 are connected to the image processing unit 108. A number of effective pixels of the image sensor 106 is about 8,200,000 (3504×2336). A display driving unit 112 and a display unit 132 are connected to the LCD control unit 111. The display unit 132 displays an image of 320×240 pixels that is obtained by converting an image captured by the image sensor 106. A battery 116 which supplies power is connected to the DC/DC converter 117.

A vibration element (piezoelectric element) 305 is bonded and fixed to the birefringent crystal plate 300 of the optical filter F that is disposed on the photographic lens 105 side, and generates vibration to remove foreign substances. The vibration control unit 109 includes a circuit to vibrate the vibration element 305. Since the control of the vibration element 305 is described in Japanese Patent Application Laid-Open No. 2007-134801, the description thereof will not be described herein. However, the CPU 101 gives to the vibration control unit 109 the command to perform vibration control.

The CPU 101 performs various kinds of control based on the control program stored in the ROM 102. In the control, there is a process that reads a signal of the captured image output from the image processing unit 108 and performs direct memory access (DMA) transfer to the RAM 103. Further, there is a process that transfers data by DMA to the display driving unit 112 from the RAM 103. Furthermore, there is a process that compresses the image data by a Joint Photographic Experts Group (JPEG) file format and stores the image data in the data storage unit 104. In addition, the CPU 101 instructs the image sensor 106, the image sensor control unit 107, the image processing unit 108, and the LCD control unit 111 to change a digital image process and a number of pixels as to the data to be acquired.

The focus detection control unit 120 performs the analog-to-digital (A/D) conversion of a voltage that is obtained from a pair of CCD line sensors 119 for focus detection, and sends the voltage to the CPU 101. Further, under an instruction of the CPU 101, the focus detection control unit 120 performs control of accumulation time and automatic gain control (AGC) of the CCD line sensor 119. The CPU 101 calculates a lens driving quantity from a current state of the focus detection of a main object to a state in which the main object is in focus, by processing the signal that is sent from the focus detection control unit 120. Then, the CPU gives an instruction to the photographic lens driving unit 125. The photographic lens driving unit 125 brings the main object into focus by moving a focus adjusting lens which is provided in the photographic lens 105 based on the instruction.

The light metering sensor 131 detects the brightness of the object, and sends a signal to the CPU 101. The CPU 101 calculates an exposure amount based on the information on the brightness, and determines one or both of shutter speed and an aperture value of the photographic lens 105.

The CPU 101 also controls an instruction of a photographing operation that is associated with the operation of the release SW 114, and a process that outputs a control signal for controlling the supply of power to each element to the DC/DC converter 117.

The RAM 103 includes an image rasterization area 103a, a work area 103b, a video random access memory (VRAM) 103c, and a temporary retreating area 103d. The image rasterization area 103a is used as a temporary buffer that temporarily stores the captured image (YUV digital signal) sent from the image processing unit 108 and JPEG compressed image data read out from the data storage unit 104. Further, the image rasterization area 103a is used as a work area dedicated to an image which is used for an image compression process and an image decompression process. The work area 103b is used for various programs. The VRAM 103c stores display data to be displayed on the display unit 132. The temporary retreating area 103d is used to temporarily save various data.

The data storage unit 104 is a flash memory. The data storage unit 104 stores captured image data on which JPEG compression is performed by the CPU 101, various attached data referred to by application, or the like in a file format.

In one embodiment, the image sensor control unit 107 includes a timing generator that supplies a transfer clock signal and a shutter signal to the image sensor 106, a circuit that removes noise of a signal output from the image sensor and performs gain processing, and an A/D conversion circuit that converts an analog signal into a 10-bit digital signal.

In one embodiment, the image processing unit 108 performs image processes, such as gamma conversion, color space conversion, white balance, automatic exposure (AE), and flash correction, of the 10-bit digital signal that is output from the image sensor control unit 107, and outputs a 8-bit digital signal having a YUV format (4:2:2).

The LCD control unit 111 receives YUV digital image data that is transferred from the image processing unit 108, or YUV digital image data that is obtained by performing JPEG decompression on the image file in the data storage unit 104. Further, after the YUV digital image data is converted into an RGB digital signal, the LCD control unit 111 outputs the RGB digital signal to the display driving unit 112. The display driving unit 112 performs control to drive the display unit 132.

The release SW 114 is used for instructing a start of the photographing operation. The release SW 114 has two-step switch positions according to pressing pressure of a release button (not illustrated). When a first position (SW 1—ON) is detected, a camera setting such as white balance and AE is locked. When a second position (SW 2—ON) is detected, an object image signal is acquired.

The battery 116 is a rechargeable secondary battery or a dry cell battery. Further, the DC/DC converter 117 is supplied with power from the battery 116, produces a plurality of power supplies by multiplying voltage and performing regulation, and supplies the power to each of the elements including the CPU 101 at a necessary voltage. The DC/DC converter 117 can control the start and stop of the supply of each voltage under the control of the CPU 101.

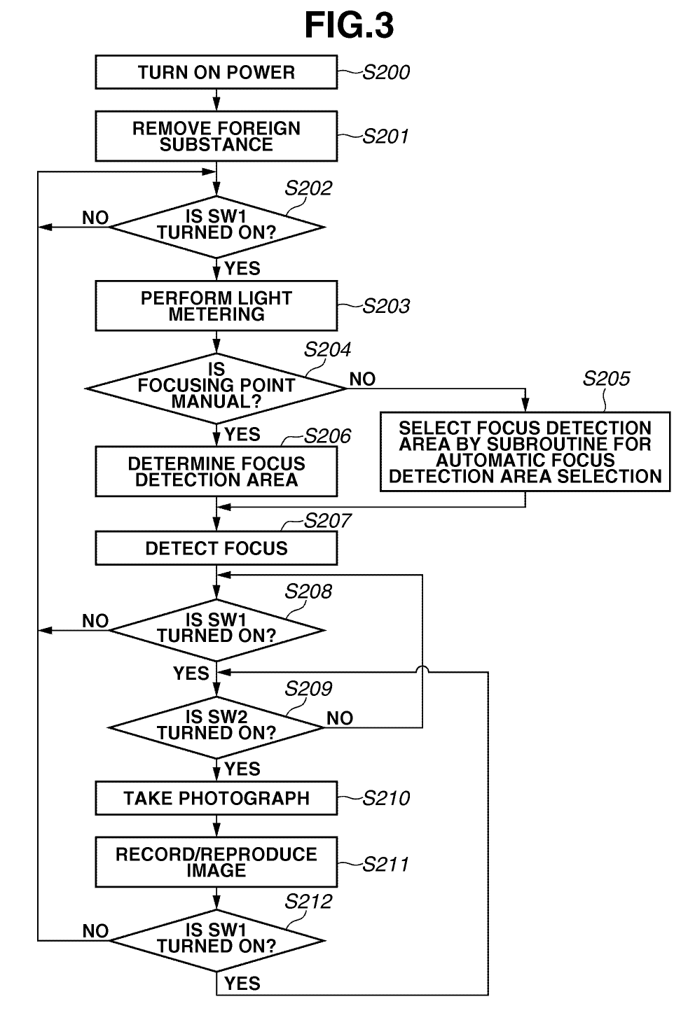

The operation of the digital camera according to the present exemplary embodiment will be described below with reference to FIG. 3. The CPU 101 reads out and executes the control program stored in the ROM 102 to perform the following operation.

First, in step S200, if a power switch (not illustrated) is turned on when the digital camera is inoperative, power of the digital camera is turned on. In step S201, the birefringent crystal plate 300 of the optical filter F is vibrated by the vibration element 305 so that foreign substances such as dust are removed.

In step S202, the release button is pressed and maintained until the SW 1 of the release SW 114 is turned on. If the SW 1 is turned on in step S202 (YES in step S202), then in step S203, brightness information of the photographic object which is divided into the form of the 3×5 matrix, or in any combination thereof, is acquired by the light metering sensor 131 and is stored in the memory. An aperture value and a shutter speed of the photographic lens, namely an exposure value of the digital camera, are determined by a calculation of a predetermined light metering algorithm based on the brightness information of the object obtained in step S203. The algorithm which calculates an optimum exposure value from the brightness information in the form of the 3×5 matrix, or in any combination thereof, that is obtained from the light metering sensor 131, may be simple averaging or may be calculation performed by maximally weighting a light metering area corresponding to a focus detection area determined in step S206.

In step S204, it is determined whether a focus detection area selecting mode of the digital camera is set to a manual mode. If the focus detection area selecting mode is set to the manual mode (YES in step S204), a photographer/user can optionally select one of a plurality of focus detection areas by operating a switch dial (not illustrated). Meanwhile, if the focus detection area selecting mode is set to an automatic mode (NO in step S204), the process proceeds to step S205. In step S205, a subroutine for automatically selecting a focus detection area selects one of fifteen focus detection areas, based on the defocus amount at the focus detection areas that correspond to fifteen focus detection area displaying units of the phase-difference type focus detection unit. Some algorithms for automatically selecting a focus detection area can be considered, but a known near point priority algorithm for weighting a central focus detection area is effective for a multipoint AF camera. In step S206, whether the manual mode or the automatic mode is set to the focus detection area selecting mode, one focus detection area is determined in the event.

Then, in step S207, a lens moving distance to be finally obtained is determined from a focus detection deviation (defocus amount) acquired at the focus detection area determined in step S206 and the lens drive sensitivity of the photographic lens 105 mounted on the digital camera. Further, a signal is sent to the photographic lens driving unit 125 according to a signal of the CCD line sensor 119 in a state prior to driving of the lens, so that the photographic lens 105 is driven by a predetermined distance.

Meanwhile, a focus detection area displaying unit (not illustrated) corresponding to the focus detection area determined in step S206 is lit, and displays a position of the object area where the photographic lens 105 is focused on. In step S208, when the photographer/user sees the field of the finder in which focusing is displayed, and continues to turn on the SW 1 (YES in step S208), then the process proceeds to step S209. If the release button is pressed and the SW 2 is turned on in step S209 (YES in step S209), then the process proceeds to step S210. In step 209, signals are sent to a shutter control unit (not illustrated), a diaphragm driving unit (not illustrated), and the image sensor control unit 107 and a known photographing operation is performed.

If it is determined in step S208 that the SW 1 is turned off (NO in step S208), the process returns to step S202 and the SW 1 waits to be turned on. Further, in step S209, if it is determined that the SW 2 is not turned on (NO in step S209), the process returns to step S208 and the SW 2 waits for the turn-on.

In the photographing operation, first, a motor is energized via a motor control unit (not illustrated), the semi-transparent main mirror 121 is tilted up, and the diaphragm of the photographic lens 105 is stopped down. Then, a magnet of the shutter 133 is energized and a first curtain of the shutter 133 is opened, so that the object light begins to accumulate in the image sensor 106. After elapse of time of a predetermined shutter speed, the accumulation of the object light in the image sensor 106 is terminated by energizing the magnet and closing a rear curtain of the shutter 133. Then, the motor is energized again so that the semi-transparent main mirror 121 is tilted down and the shutter is charged. Accordingly, a series of an operation of shutter release sequence (photographing operation) is terminated. The light from the object image accumulates in the image sensor 106 by the above described operation.

In step S211 of one embodiment, the object image exposed to the image sensor 106 is photoelectrically converted by the photographing operation of the step S210, is converted into the digital data having about 8,200,000 (3504×2336) pixels in the image processing unit 108, and then is temporarily stored in the RAM 103a. The image digital data which has 3504×2336 pixels and is stored in the RAM 103a is converted into image data having 320×240 pixels to be displayed on the display unit 132, and are stored again in the VRAM 103c for display. When the image data having 320×240 pixels is displayed on the display unit 132, the photographer/user can confirm the captured image. Meanwhile, a JPEG compress process is performed on the image digital data that has 3504×2336 pixels and is stored in the RAM 103a, and the image digital data is then recorded in the data storage unit 104 (recording medium such as CompactFlash®) as image data.

In step S212, it is determined whether the SW 1 is turned on or off while the image is being displayed. If the SW 1 is turned on (YES in step S212), the entire image display of the display unit 132 is turned off, the process returns to step S209, and the SW 2 waits for the turn-on. If the SW 1 is not turned on (NO in step S212), the process returns to step S202 and the SW 1 waits for the turn-on.

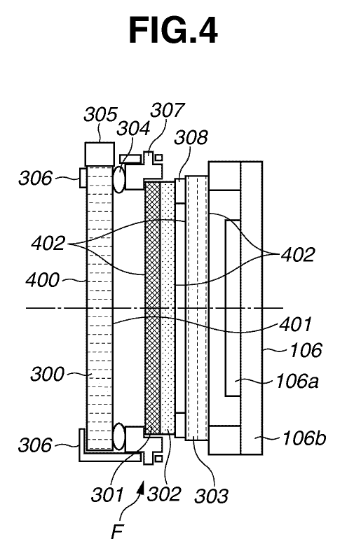

The optical filter F will be described in detail below with reference to FIGS. 4 to 9. FIG. 4 is an enlarged cross-sectional view of a peripheral portion of the image sensor 106 and the optical filter F. The digital camera according to the present exemplary embodiment employs an optical low-pass filter that performs 4-spot image separation to suppress generation of a false color of the captured image on an array (Bayer array) of a color filter of the image sensor.

In one embodiment, the birefringent crystal plate 300 has a rotation angle of 0°, and separates the object image into two images in a horizontal direction (horizontal 2-spot separation). A width of the spot image separation by the birefringent operation of the crystal is about 5.87 μm when a thickness of crystal having a cutting angle of 45° is 1 mm. Accordingly, a necessary width of the separation can be easily calculated by proportionally multiplying the thickness of the crystal by the value 5.87. The birefringent crystal plate 300 forms a first optical member.

An infrared absorption filter 301 functions to substantially match the spectral sensitivity of the image sensor 106 to the sensitivity of a human eye. A depolarization plate 302 (λ/4 wavelength plate) made of crystal depolarizes the object luminous flux that is linearly polarized by passing through the birefringent crystal plate 300 to restore the object luminous flux to a circularly polarized light again, and emits the object luminous flux. The infrared absorption filter 301 and the depolarization plate 302 are bonded to each other, and form a second optical member.

In one embodiment, the birefringent crystal plate 303 having a rotation angle of 90° separates the object image into two images in a vertical direction (vertical 2-spot separation) The birefringent crystal plate 303 forms a third optical member. The birefringent crystal plate 303 is bonded to a ceramic package 106b to function to protect the light-receiving part (light-receiving chip) 106a of the image sensor 106.

As described above, the vibration element 305 is bonded and fixed to an upper end of the birefringent crystal plate 300. The vibration element 305 vibrates the birefringent crystal plate 300, so that foreign substances such as dust attached to the surface of the birefringent crystal plate 300 facing the photographic lens 105 side can be removed. The vibration element 305 is a laminated piezoelectric element in which piezoelectric bodies and internal electrodes are alternately laminated. Since large amplitude (displacement) is generated in a laminated direction of the vibration element, the birefringent crystal plate 300 can be significantly vibrated and displaced in a direction orthogonal to a photographing optical axis.

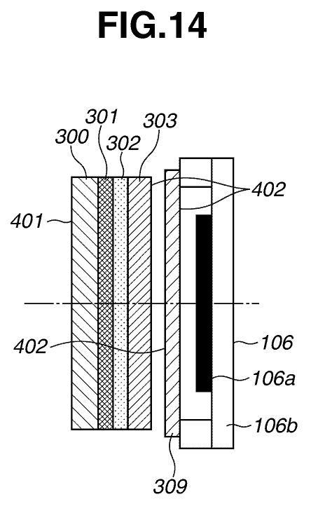

As described above, effects of a low-pass filter and infrared absorption (visibility correction) are realized by the optical filter F that includes the first to third optical members. If the optical filter is formed of three optical members as described above, the following effects can be gained. More specifically, the optical member can efficiently generate vibration by optimizing only the first optical member (birefringent crystal plate 300) which generates vibration to remove foreign substances including its shape. In addition, manufacturing cost can be reduced by substituting the cover glass 309 of the image sensor of the optical filter which is illustrated in FIG. 14 with the third optical member (birefringent crystal plate 303) that is a part of the optical filter.

The configuration of the first to third optical members will be described below. A holding member 307 is disposed between the first optical member (birefringent crystal plate 300) and the second optical member (a bonded body formed by the infrared absorption filter 301 and the depolarization plate 302). An elastic member 304 which is interposed between the holding member 307 and the birefringent crystal plate 300, is made of elastomer (high molecular material). The birefringent crystal plate 300 is pressed against the elastic members 304 by pressing members 306 that are formed of a metal plate having elasticity, so that the birefringent crystal plate 300 is held to float on the holding member 307. Accordingly, the birefringent crystal plate 300 can vibrate corresponding to expansion and contraction of the piezoelectric element 305, and damage to the birefringent crystal plate 300 due to the vibration can be prevented. Further, the vicinity of four sides of the birefringent crystal plate 300 and the holding member 307 are hermetically sealed with the elastic member 304 so that a gap is not formed. Accordingly, a light-emitting surface of the birefringent crystal plate 300 and an incident surface of the infrared absorption filter 301 are hermetically sealed. The filter unit that includes the first and second optical members and the third optical member (birefringent crystal plate 303) are in close contact with each other and fixed by an adhesive sheet 308 so that foreign substances do not enter a gap therebetween.

According to the above described configuration, an effective optical range of the optical filter F can be placed in a sealed space, so that once the filter unit is assembled, foreign substances do not enter from the outside.

An anti-reflection coat (AR coat) 400 which is an anti-reflection multilayer film having conductivity is deposited on the surface (incident surface for photographic luminous flux) of the first optical member (birefringent crystal plate 300) facing the photographic lens 105 side. The AR coat 400 has a foreign substance-attachment preventing film which is made of a material including fluorine at an outermost layer (outermost surface). Further, a UV-IR cutting coat 401 which is a dichroic multilayer film having an effect of cutting infrared and ultraviolet light is deposited on the surface (light-emitting surface for photographic luminous flux) of the first optical member (birefringent crystal plate 300) facing the image sensor 106 side to improve color reproducibility of a captured image.

A common anti-reflection coat (AR coat) 402 is formed on both surfaces of the second optical member (the bonded body formed by the infrared absorption filter 301 and the depolarization plate 302) and on both surfaces of the third optical member (birefringent crystal plate 303) bonded to the image sensor 106.

There are two reasons why a lower layer of the foreign substance-attachment preventing film made of a material including fluorine is formed of not the common UV-IR cutting coat but the AR coat 400, and is formed on the surface of the optical filter F facing the photographic lens 105 side.

The first reason is as follows: since a number of layers of the AR coat 400 is smaller than that of the UV-IR cutting coat by one digit, microparticles of a deposition material scattered to other portions than a target object, namely dust is less generated. Accordingly, if an anti-reflection material is deposited, a cleaning cycle of a deposition chamber is longer as compared to when a UV-IR cutting material is deposited. In both cases when a fluorine material is deposited after the deposition of the anti-reflection material and when the fluorine material is deposited after the deposition of the UV-IR cutting material, the cleaning cycle of the deposition chamber is shorter as compared to when the fluorine material is not deposited. If the fluorine material is deposited after the deposition of the UV-IR cutting material which has a short cleaning cycle, the cleaning cycle is further shortened. Therefore, production efficiency significantly deteriorates. In the present exemplary embodiment, the fluorine material is deposited after the deposition of the anti-reflection material which has a longer cleaning cycle. Therefore, the fluorine material can be deposited without significantly deteriorating the production efficiency.

The second reason is as follows: the UV-IR cutting coat 401 is not formed on the surface (incident surface for photographic luminous flux) of the first optical member (birefringent crystal plate 300) facing the photographic lens 105 side, and is formed on a surface in a space that is hermetically sealed by the first and second optical members. Accordingly, even though the UV-IR cutting coat 401 is electrostatically charged, foreign substances are not attached thereto. Therefore, the UV-IR cutting coat 401 does not need to have conductivity. In the present exemplary embodiment, since the UV-IR cutting coat 401 does not need to have conductivity, the UV-IR cutting coat 401 may be deposited by ion-assisted deposition that is excellent in reliability and optical performance as compared to common vacuum deposition.

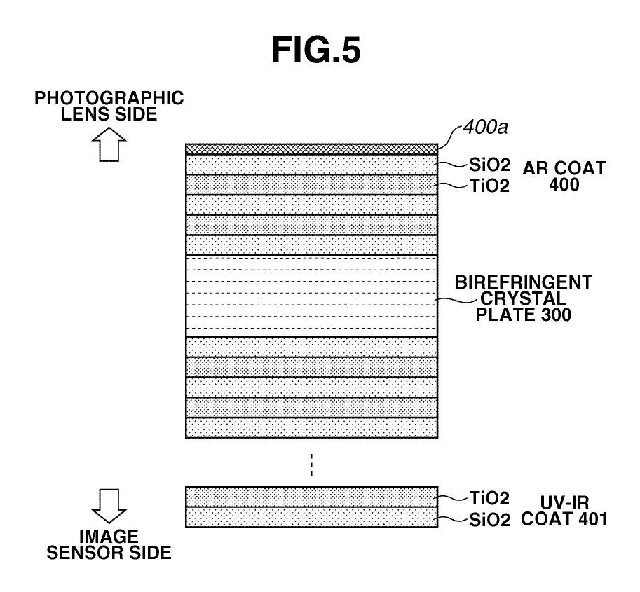

The UV-IR cutting coat 401 and the AR coat 400 including the foreign substance-attachment preventing film which is formed on the surface of the first optical member (birefringent crystalplate 300) will be further described with reference to FIG. 5. FIG. 5 is an enlarged view schematically illustrating the shape of the birefringent crystal plate 300 in a thickness direction. An actual thickness of the birefringent crystal plate 300 is about 1 mm, and a thickness of one layer of SiO₂ or TiO₂ that is a deposition material of a deposited layer is about 100 nm.

First, the AR coat 400 including the foreign substance-attachment preventing film will be described. Five layers of AR coat 400 which are formed by alternately laminating SiO₂ and TiO₂ films in vacuum deposition are formed on the surface of the birefringent crystal plate 300 facing the photographic lens 105 side, and the foreign substance-attachment preventing film 400a is formed on the outermost layer of the AR coat 400.

The foreign substance-attachment preventing film 400a will be described below. Coating a surface of a base material with a material containing fluorine atoms is effective in preventing the attachment of foreign substances. Since a radius and polarizability of the fluorine atom are small, electro-negativity is the highest among all elements. Further, since a binding energy of a bond between carbon and fluorine is very large, the bond between carbon and fluorine is excellent in heat resistance and light resistance. Furthermore, since the polarizability of the bond between carbon and fluorine is small, an intermolecular cohesive force is also small, so that surface free energy may be decreased. The surface free energy is related to a variance term component due to a Van der Waals' forces, a polar term component relating to a Coulomb electrostatic force, a term based on a hydrogen bonding force, and an intermolecular force such as other metallic binding forces. Coating with a fluorine-based material having small surface free energy is effective in preventing the attachment of foreign substances such as dust.

It is desirable that a compound containing a perfluoroalkyl group obtained by substituting hydrogen of a hydrocarbon group with fluorine, for example, perfluoroalkyl silane is used as a fluorine-based material. Further, as described in Japanese Patent Application Laid-Open No. 2006-163275, using MgF₂ which is one of a fluorine compound and generally used as a deposition material for surface coating is suitable for preventing the attachment of foreign substances although the same effect as the coating of a fluorine-based resin is not obtained.

However, if the foreign substance-attachment preventing film 400a is merely formed on the surface of the substrate, the attachment of foreign substances is not sufficiently prevented. If a film provided below the foreign substance-attachment preventing film 400a, that is, the AR coat layer in the present exemplary embodiment is charged, foreign substances are apt to be attached due to an electrostatic force. The AR coat layer which is provided below the foreign substance-attachment preventing film 400a will be described below.

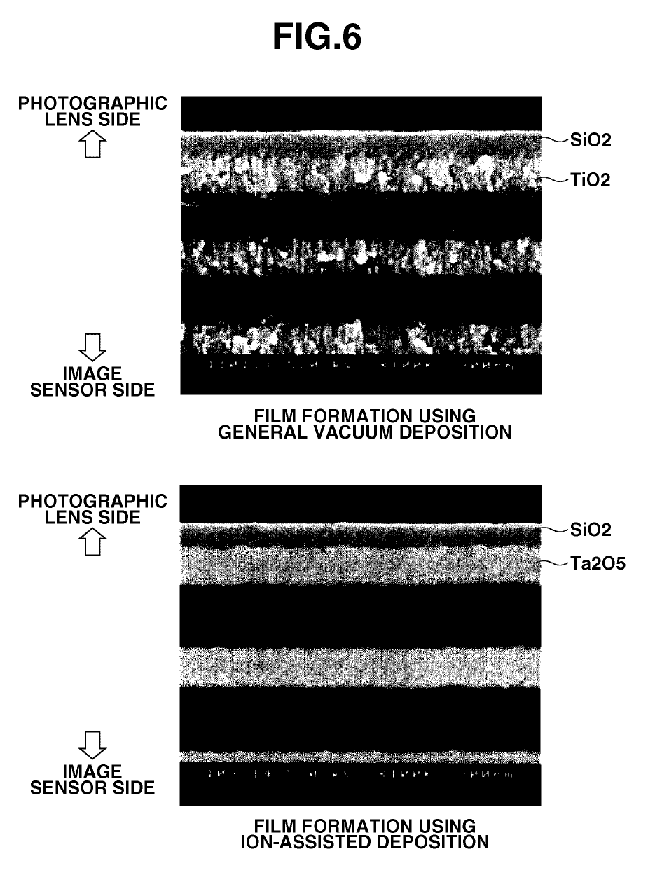

SiO₂ and TiO₂ which form the AR coat layers illustrated in FIG. 5, are deposited by common vacuum deposition that is most generally used. If these deposition materials are deposited by the vacuum deposition, the deposited layer of each deposition material has a porous shape. The shape is illustrated in an upper photograph of FIG. 6. FIG. 6 illustrates cross-sections of the UV-IR multilayer films deposited on a crystal substrate that are captured by a scanning electron microscope (SEM). As illustrated in the upper photograph of FIG. 6, a TiO₂ film clearly shows the porous shape. Meanwhile, a lower photograph of FIG. 6 illustrates the cross-section of the UV-IR multilayer film which is formed using SiO₂ and Ta₂O₅ (deposition materials) by ion-assisted deposition (IAD) that is one of the vacuum deposition. It is found that dense films using SiO₂ and Ta₂O₅ are formed as compared to coats of the common vacuum deposition.

According to the ion-assisted deposition, a substrate is irradiated with gaseous ions having several hundred eV during vacuum deposition, so that a densely deposited film can be formed. In contrast, the followings are generally known as for common vacuum deposition. More specifically, since a formed porous layer has low density and water absorbability, a refractive index of the deposited layer and a spectral characteristic of the coating are changed when the layer contains moisture. Meanwhile, the electrical resistance of the deposited layers may be changed since these porous layers adsorb moisture therein.

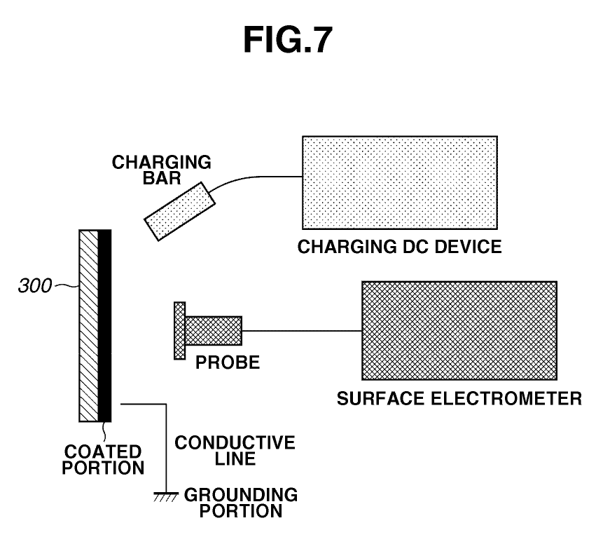

An experiment has been performed to measure whether electric charges remain on the deposition surface (become 0 V) when the deposition surface of the birefringent crystal plate 300 is forcibly charged and is grounded to a conductive line at a ground level. FIG. 7 illustrates the summary of the experiment. In FIG. 7, a charging DC device which provides electric charges to the deposition surface of the birefringent crystal plate 300 may easily charge the crystal plate by moving a charging bar closer to the crystal plate. Next, a probe of a surface electrometer is brought closer to the deposition surface of the birefringent crystal plate 300 to check that the deposition surface is charged with 500 V or more. Then, the deposition surface is grounded by a conductive line at a ground level. The experiment has been performed to measure whether electric charges remain on the deposition surface (become 0 V) again by a surface electrometer, and it has been determined whether electric charges are lost from the deposition surface of the birefringent crystal plate 300.

Table 1 shows experimental results. Samples are formed by applying various kind of coating on a crystal plate. UV-IR1 is a general UV-IR cutting coat in which a SiO₂ film is formed on the outermost surface and TiO₂ and SiO₂ films with a thickness of about 100 nm are alternately laminated therebelow toward the crystal substrate to form forty layers. The UV-IR1 is formed by common vacuum deposition. UV-IR2 is a UV-IR cutting coat in which a SiO₂ film is formed on the outermost surface and Ta₂O₅ and SiO₂ films with a thickness of about 100 nm are alternately laminated therebelow toward the crystal substrate to form forty layers, and has the same spectral specifications as the UV-IR1. The UV-IR2 is formed by ion-assisted deposition. AS results of the charging experiment of these two coating samples, electric charges are lost in the UV-IR1 coat formed by the common vacuum deposition due to grounding by the conductive line, so that potential of the deposition surface becomes 0 V. However, most electric charges were not changed in the UV-IR2 coat formed by the ion-assisted deposition, and were not removed.

AR1 is an anti-reflection coat that is formed with three layers including a SiO₂ film formed on the outermost surface and ZrO₂ and Al₂O₃ films formed below the SiO₂ film. When the charging experiment was performed on the AR1 coat, electric charges were not removed.

AR2 is an AR coat having a film configuration similar to that of UV-IR1 in which a SiO₂ film is formed on the surface, TiO₂ and SiO₂ films with a thickness of about 100 nm are alternately laminated toward the crystal substrate to form five layers, and a MgF₂ film with a thickness of about 100 nm is formed on the SiO₂ film of the surface layer as a foreign substance-attachment preventing film of an outermost surface layer. The charging experiment was performed on the AR2 coat, and it could be confirmed that electric charges were removed. In addition, the charging experiment was performed on AR3 coat in which a film of a fluorine-based material with a thickness of about 10 nm was formed on the outermost layer as a foreign substance-attachment preventing film instead of the MgF₂ film of the AR2 coat, and it could be confirmed that electric charges were removed.

TABLE 1

| COAT | DEPOSITION | DEPOSITION | REMOVAL OF |
|---|---|---|---|
| NAME | MATERIAL | METHOD | CHARGING |
| UV-IR1 | SiO₂, TiO₂ | COMMON VACUUM | ◯ |
| | | DEPOSITION | |
| UV-IR2 | SiO₂, Ta₂O₅ | IAD DEPOSITION | X |
| AR1 | SiO₂, ZrO₂, | COMMON VACUUM | X |
| | Al₂O₃ | DEPOSITION | |
| AR2 | MgF₂, SiO₂, TiO₂ | COMMON VACUUM | ◯ |
| | | DEPOSITION | |
| AR3 | FLUORINE- | COMMON VACUUM | ◯ |
| | BASED | DEPOSITION | |
| | MATERIAL, | | |
| | SiO₂, TiO₂ | | |

From the above description, a coat having porous TiO₂ film structure in which SiO₂ and TiO₂ films are alternately formed on the crystal substrate by common vacuum deposition, can remove the electric charges thereof by grounding the deposition surface. In addition, a layer of the foreign substance-attachment preventing film which is made of a high molecular material containing fluorine or MgF₂ (magnesium fluoride) and is formed on the SiO₂ film formed on the surface of the coat, does not prevent the removal of electric charges.

In the present exemplary embodiment, to prevent attachment of foreign substances to the birefringent crystal plate 300, films made of SiO₂ and TiO₂ (deposition materials of the deposited layer) are alternately formed on the birefringent crystal plate 300 by vacuum deposition, and a foreign substance-attachment preventing film 400a is formed on the outermost layer thereof. Accordingly, the AR coat 400 that does not generate an electrostatic force and has low surface free energy, in other words, to which foreign substances is less attached can be provided.

The UV-IR cutting coat 401 will be described below. The UV-IR cutting coat 401 is provided in order to cut predetermined wavelength regions since the spectral sensitivity of the image sensor cannot be matched with the sensitivity of a human eye only by the infrared absorption filter 301. More specifically, the UV-IR cutting coat cuts the following three wavelength regions. That is, a wavelength region near 400 nm is cut to reduce bleeding of blue color of the photographic lens 105. A wavelength region near 700 nm (red light) which is gently absorbed and dimmed by the infrared absorption filter 301 is sharply cut. A wavelength region exceeding 1000 nm (an infrared region) is cut in which the transmissivity of the infrared absorption filter 301 is gradually increased.

As illustrated in FIG. 5, the UV-IR cutting coat 401 has the SiO₂ film which is formed on the outermost surface and the SiO₂ and TiO₂ films with a thickness of about 100 nm which are alternately laminated therebelow toward the crystal substrate by the vacuum deposition to form about forty layers. Alternatively, the UV-IR cutting coat may have the SiO₂ film which is formed on the outermost surface and the Ta₂O₅ and SiO₂ films which are laminated therebelow toward the crystal substrate to form about forty layers by ion-assisted deposition.

As described above, the AR coat 400 is disposed on the front surface of the optical filter F that includes the infrared absorption filter 301 and an anti-static effect is used to prevent the attachment of foreign substances. In contrast, since the UV-IR cutting coat 401 is disposed inside the optical filter F, charging does not need to be considered. Accordingly, the UV-IR cutting coat 401 can be formed by ion-assisted deposition which can form a dense film having high strength and spectral characteristic which hardly changes, which is significantly beneficial for spectral characteristics and environmental reliability.

In FIG. 4, the UV-IR cutting coat 401 is disposed on a rear surface of the birefringent crystal plate 300 (the surface facing the image sensor 106 side), but may be disposed on the surface of the infrared absorption filter 301 facing the photographic lens 105 side (i.e., a surface facing the rear surface of the birefringent crystal plate 300).

Further, when the infrared absorption filter 301 and the depolarization plate 302 of the second optical member are disposed in inverted positions (back to front), a function of the second optical member is completely the same. When the infrared absorption filter 301 and the depolarization plate 302 are inverted, the UV-IR cutting coat 401 is disposed on the surface of the depolarization plate 302 facing the photographic lens 105 side, that is a surface facing the rear surface of the birefringent crystal plate 300.

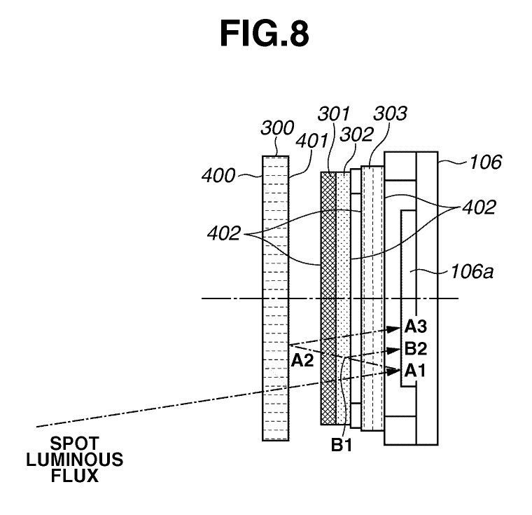

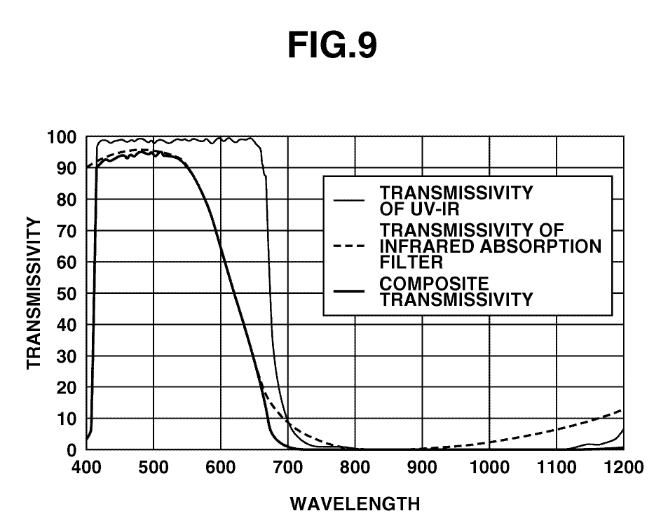

In other words, the UV-IR cutting coat 401 is formed on the rear surface of the first optical member (surface facing the image sensor 106 side) or on the surface of the second optical member facing the photographic lens 105 side. The reason for this configuration will be described with reference to FIGS. 8 and 9.

FIG. 8 illustrates only optical elements of FIG. 4, and the disposition of the optical elements and coats formed on the surfaces of the optical elements are the same as described in FIG. 4. FIG. 9 illustrates characteristic curves of the spectral transmissivity of the UV-IR cutting coat 401, the transmissivity of the infrared absorption filter 301, and the composite transmissivity of these two pieces of the transmissivity. The spectrum of the object light entering the image sensor 106 is determined by the composite transmissivity. As seen from FIG. 9, the UV-IR cutting coat 401 is designed so that the infrared transmissivity becomes 50% in the vicinity of a wavelength of 670 nm. In other words, reflectance of the UV-IR cutting coat 401 is high (50% or more) in the infrared region at a wavelength of 670 nm or more. Meanwhile, the reflectance is suppressed within 2% at a wavelength of 400 to 670 nm.

How spot light from the object enters the image sensor 106 (is captured an image) as ghost light in FIG. 8 will be described. In one embodiment the spot light from object which enters from the photographic lens 105 passes through the birefringent crystal plate 300, the infrared absorption filter 301, and the depolarization plate 302. Then, the spot light passes through the birefringent crystal plate 303, and enters alight-receiving part 106a of the image sensor 106. Generally, the reflectance of each of the AR coats 400 and 402 is about 1% or less in a visible range at a wavelength of 400 to 700 nm, but the reflectance of the light-receiving part 106a is relatively high (about 6%) over a wide range. Thus, reflected luminous flux is generated at a point A1 on the surface of the light-receiving part 106a. The reflected luminous flux returns to the optical filter F. However, the reflectance of the UV-IR cutting coat 401 of the optical filter F is high in the visible range, that is, 50% or more in the visible range at the wavelength of 670 to 700 nm. Accordingly, the spot luminous flux reflected at the point A1 is reflected at a point A2 again, and reenters a point A3 on the surface of the light-receiving part 106a of the image sensor 106. As a result, in the captured image the ghost light which is out of focus and has a diameter substantially corresponding to a distance formed by the points A1 and A3 is generated close to the spot light that is the focused object.

The spot luminous flux which is reflected at the point A1 further passes through the infrared absorption filter 301 two times until finally reaching the point A3. The transmissivity of the infrared absorption filter 301 is over 10% at the wavelength of 670 to 700 nm. Accordingly, when the reflectance on the surface of the light-receiving part 106a at the point A3 is 6% and average reflectance of the UV-IR cutting coat 401 is 75% at the wavelength of 670 to 700 nm, intensity of the ghost light is attenuated to 0.045% (=6%×0.75×0.1×0.1). Meanwhile, the light reflected at each interface of media on which the AR coat is formed also enters the image sensor 106 as the ghost light. However, since the reflectance of the AR coat 400 is about 1%, the intensity of the ghost light becomes 0.06% (=6%×0.01) in the visible range at the wavelength of 400 to 700 nm. The ghost light is generated on five surfaces that correspond to the number of interfaces. Accordingly, when the ghost lights overlap each other, the ghost light that has a flat spectrum in the visible wavelength of 400 to 700 nm and an intensity of about 0.3 to 0.4% of the intensity of direct light is captured without bringing discomfort.

The deposition surface of the UV-IR cutting coat 401 is disposed on the rear surface of the birefringent crystal plate 300 in the present exemplary embodiment. However, as long as being positioned between the light-emitting surface of the birefringent crystal plate 300 and the incident surface of the infrared absorption filter 301, the deposition surface of the UV-IR cutting coat 401 maybe formed on any surface. For example, the deposition surface of the UV-IR cutting coat 401 may be provided on the incident surface of the infrared absorption filter 301 (surface facing the photographic lens 105 side). In this case, the size of a ghost light is slightly reduced and the intensity of the ghost light is increased, but substantially the same ghost light is captured.

The intensity of the ghost light, when the UV-IR cutting coat 401 is disposed closer to the image sensor 106 than the infrared absorption filter 301, will be described. As an example, it is assumed that the UV-IR cutting coat 401 is formed on the surface of the depolarization plate 302 facing the image sensor 106 side, and the intensity of the ghost light will be considered. In FIG. 8, the reflected luminous flux of 6% which is generated at the point A1 on the surface of the light-receiving part 106a is reflected by the surface of the depolarization plate 302 with a high average reflectance of 75% at the wavelength of 670 to 700 nm. Then, the reflected luminous flux enters the light-receiving part 106a as it is. If the reflectance is calculated at the same wavelength of 670 to 700 nm, the high intensity of 4.5% (=6%×0.75) is obtained. Since the ghost light is generated on five surfaces on the other interfaces which have the reflectance of 0.06%, the intensity of overlapped ghost light is about 5% over the visible range of 400 to 700 nm. The intensity of overlapped ghost light at the wavelength of 670 to 700 nm accounts for about 90%. As a result, in the captured image, red ghost light which has a diameter substantially corresponding to a distance formed by the points A1 and B2 and has a smaller size but very high intensity as compared to the above described example is generated close to the spot light that is the focused object, so that image quality significantly deteriorates.

Accordingly, in order to obscure the ghost light, it is important for the image quality to dispose the UV-IR cutting coat 401 closer to the photographic lens 105 than the infrared absorption filter 301.

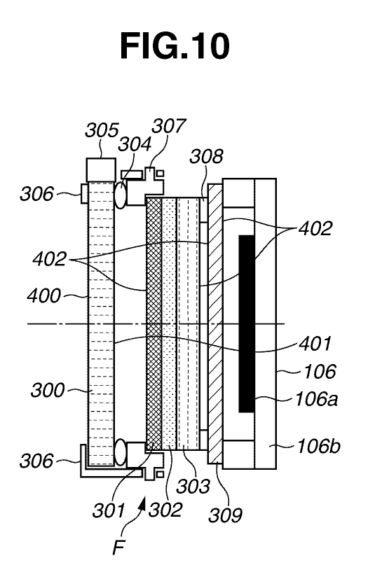

A second exemplary embodiment according to the present invention will be described below with reference to FIG. 10. FIG. 10 is an enlarged cross-sectional view of a peripheral portion of an image sensor 106 and an optical filter F, and corresponds to FIG. 4 of the first exemplary embodiment. The same elements as those illustrated in FIG. 4 are denoted by the same reference numerals.

The first and second exemplary embodiments are different from each other in that a second optical member of the second exemplary embodiment includes a birefringent crystal plate 303 having a rotation angle of 90° in addition to the second optical member of the first exemplary embodiment that is the bonded body formed by the infrared absorption filter 301 and the depolarization plate 302. That is, the second optical member of the second exemplary embodiment includes three optical elements that are bonded to one another.

The first and second exemplary embodiments are similar to each other in that an AR coat 400 which includes a foreign substance-attachment preventing film on the outermost layer is deposited on the surface of the first optical member (birefringent crystal plate 300) facing the photographic lens 105 side and a UV-IR cutting coat 401 is deposited on the rear surface thereof. However, since a low-pass effect is completed by the first and second optical elements of the second exemplary embodiment, a cover glass (protective glass) 309 functions to protect a light-receiving part 106a of an image sensor 106. Like the first exemplary embodiment, a surface on which the UV-IR cutting coat 401 is formed may not be the rear surface of the birefringent crystal plate 300 but the surface (incident surface for photographic luminous flux) of the second optical element facing the photographic lens 105 side.

A general image sensor in which the cover glass 309 is used for the image sensor 106 may be used in the second exemplary embodiment. Accordingly, a degree of freedom in selecting a manufacturer of the image sensor is increased, which is beneficial for supply and cost reduction of the image sensor. This is because to manufacture an image sensor in which the birefringent crystal plate 303 is attached to the ceramic package 106b with high reliability in the first exemplary embodiment, a linear expansion coefficient of a material of the ceramic package 106b is to be made close to that of crystal as much as possible.

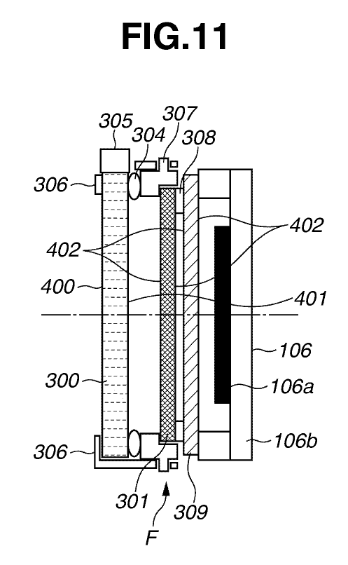

A third exemplary embodiment according to the present invention will be described below with reference to FIG. 11. FIG. 11 is an enlarged cross-sectional view of a peripheral portion of an image sensor 106 and an optical filter F, and corresponds to FIG. 4 of the first exemplary embodiment. The same elements as those illustrated in FIG. 4 are denoted by the same reference numerals.

The first and third exemplary embodiments are different from each other in that a second optical member of the third exemplary embodiment includes only an infrared absorption filter 301.

The first and third exemplary embodiments are similar to each other in that an AR coat 400 which includes a foreign substance-attachment preventing film on the outermost layer is deposited on the surface of the first optical member (birefringent crystal plate 300) facing the photographic lens 105 side and a UV-IR cutting coat 401 is deposited on the rear surface thereof. Further, like the second exemplary embodiment, the image sensor 106 is protected by a cover glass 309.

In the third exemplary embodiment, only one birefringent crystal plate is provided, so that only horizontal 2-spot image separation is performed. Accordingly, a low-pass effect is not obtained in the vertical direction, and a possibility of generation of false color is increased. However, since two crystal plates may be removed, the third exemplary embodiment is suitable for an inexpensive digital camera. A birefringent crystal plate having a rotation angle of 90° may be used instead of that having a rotation angle of 0°.

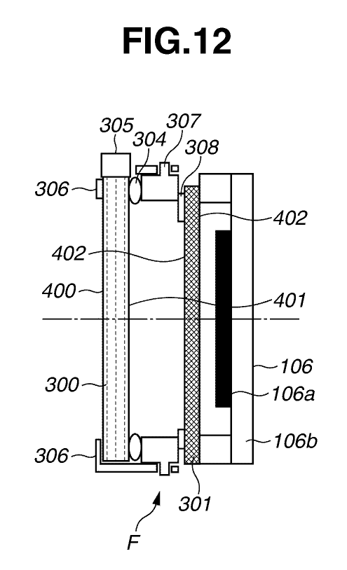

A fourth exemplary embodiment according to the present invention will be described below with reference to FIG. 12. FIG. 12 is an enlarged cross-sectional view of a peripheral portion of an image sensor 106 and an optical filter F, and corresponds to FIG. 4 of the first exemplary embodiment. The same elements as those illustrated in FIG. 4 are denoted by the same reference numerals.

The first and fourth exemplary embodiments are different from each other in that a second optical member is only an infrared absorption filter 301 like in the third exemplary embodiment. Further, the infrared absorption filter 301 is bonded to the image sensor 106 and functions to protect a light-receiving chip 106a of the image sensor 106.

The first and fourth exemplary embodiments are similar to each other in that an AR coat 400 which includes a foreign substance-attachment preventing film on the outermost layer is deposited on the surface (incident surface for photographic luminous flux) of the first optical member (birefringent crystal plate 300) facing the photographic lens 105 side and a UV-IR cutting coat 401 is deposited on the rear surface thereof.

In the fourth exemplary embodiment, horizontal 2-spot image separation is performed like the third exemplary embodiment. However, since the cover glass 309 is not needed, manufacturing cost may be further reduced. Meanwhile, a material which is used for the ceramic package 106b needs to be selected from materials that have a linear expansion coefficient close to that of the UV-IR cutting coat 401.

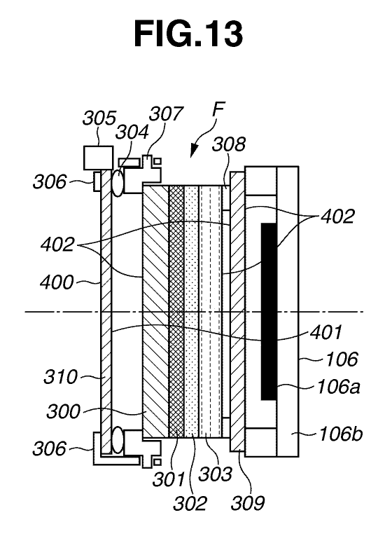

A fifth exemplary embodiment according to the present invention will be described below with reference to FIG. 13. FIG. 13 is an enlarged cross-sectional view of a peripheral portion of an image sensor 106 and an optical filter F, and corresponds to FIG. 4 of the first exemplary embodiment. The same elements as those illustrated in FIG. 4 are denoted by the same reference numerals.

In the fifth exemplary embodiment, a second optical member is an optical filter having a structure in which four optical elements including a birefringent crystal plate 300 having a rotation angle of 0°, an infrared absorption filter 301, a depolarization plate 302, and a birefringent crystal plate 303 having a rotation angle of 90° are bonded similar to that illustrated in FIG. 14. A common anti-reflection coat 402 is formed on the front surface of the optical filter having four-element bonded structure.

Meanwhile, a glass plate 310 which is made of S-BSL7 and has a good optical characteristic forms a first optical member. An AR coat 400 which includes a foreign substance-attachment preventing film on the outermost layer is deposited on the surface of the first optical member (glass plate 310) facing the photographic lens 105 side, and a UV-IR cutting coat 401 is deposited on the rear surface thereof. Further, in the present exemplary embodiment, the glass plate 310 is an object to be vibrated to remove foreign substances attached to the surface of the glass plate facing the photographic lens 105 side.

In the fifth exemplary embodiment, when optimizing vibration generation for removing foreign substances, the optical filter F which includes a conventional infrared absorption filter and optical low-pass filter does not need to be considered. Only parameters relating to the glass plate 310 that is the object to be vibrated, such as a material, thickness, and shape thereof, and a driving voltage and a driving waveform of a vibration element need to be determined and optimized in generating vibration. Once the vibration is optimized, vibration mechanism does not need to be changed even though specifications of the optical filter F are changed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-149637 filed Jun. 6, 2008, which is hereby incorporated by reference herein in its entirety.

1. An optical filter that is disposed in front of an image sensor, the optical filter comprising:
a first optical member; and
a second optical member that is disposed closer to the image sensor than the first optical member,
wherein an anti-reflection multilayer film is formed on an incident surface of the first optical member,
a film which is made of a material containing fluorine is formed on an outermost layer of the anti-reflection multilayer film, and
a dichroic multilayer film is formed between a light-emitting surface of the first optical member and an incident surface of the second optical member.

2. The optical filter according to claim 1, wherein SiO₂ and TiO₂ films are formed in the anti-reflection multilayer film

3. The optical filter according to claim 1, wherein the outermost layer of the anti-reflection multilayer film is made of a compound containing a perfluoroalkyl group.

4. The optical filter according to claim 1, wherein the outermost layer of the anti-reflection multilayer film is made of MgF₂.

5. The optical filter according to claim 2, wherein SiO₂ and TiO₂ are formed by vacuum deposition.

6. The optical filter according to claim 1, wherein the dichroic multilayer film is deposited by ion-assisted deposition.

7. The optical filter according to claim 1, wherein the second optical member absorbs an infrared component.

8. The optical filter according to claim 1, wherein the anti-reflection multilayer film has conductivity.

9. (canceled)

10. The optical filter according to claim 1, further comprising:
a holding member configured to hold the first and second optical members.

11. The optical filter according to claim 10, wherein a gap between the light-emitting surface of the first optical member and the incident surface of the second optical member are sealed.

12. An optical filter that is disposed in front of an image sensor, the optical filter comprising:
an optical member;
an anti-reflection multilayer film that is formed on an incident surface of the optical member; and
a dichroic multilayer film that is formed on a light-emitting surface of the optical member,
wherein a film which is made of a material containing fluorine is formed on an outermost layer of the anti-reflection multilayer film.

13. The optical filter according to claim 12, wherein the anti-reflection multilayer film includes SiO₂ and TiO₂ that are formed in a shape of a porous film.

14. The optical filter according to claim 12, wherein the outermost layer of the anti-reflection multilayer film is made of a compound containing a perfluoroalkyl group.

15. The optical filter according to claim 12, wherein the outermost layer of the anti-reflection multilayer film is made of MgF₂.

16. The optical filter according to claim 12, wherein SiO₂ and TiO₂ films are formed in the anti-reflection multilayer film by vacuum deposition.

17. The optical filter according to claim 12, wherein the dichroic multilayer film is deposited by ion-assisted deposition.

18. The optical filter according to claim 12, wherein the optical member is held to be able to vibrate, and the optical member is held so that the light-emitting surface of the optical member is sealed.

19. An imaging apparatus comprising:
a first optical member that is disposed in front of an image sensor; and
a second optical member that is disposed on a light-emitting surface side of the first optical member and in front of the image sensor,
wherein an anti-reflection multilayer film is formed on an incident surface of the first optical member,
a film which is made of a material containing fluorine is formed on an outermost layer of the anti-reflection multilayer film, and
a dichroic multilayer film is formed between the light-emitting surface of the first optical member and an incident surface of the second optical member.

20. The imaging apparatus according to claim 19, wherein the anti-reflection multilayer film includes SiO₂ and TiO₂ that are formed in a shape of a porous film.

21. The imaging apparatus according to claim 19, wherein the outermost layer of the anti-reflection multilayer film is made of a compound containing a perfluoroalkyl group.

22. The imaging apparatus according to claim 19, wherein the outermost layer of the anti-reflection multilayer film is made of MgF₂.

23. The imaging apparatus according to claim 19, wherein SiO₂ and TiO₂ films are alternately formed in the anti-reflection multilayer film by vacuum deposition.

24. The imaging apparatus according to claim 19, wherein the dichroic multilayer film is deposited by ion-assisted deposition.

25. The imaging apparatus according to claim 19, wherein the anti-reflection multilayer film has conductivity.

26. The imaging apparatus according to claim 19, further comprising:
a holding member configured to hold the first and second optical members; and
a vibration unit configured to vibrate the first optical member.

27. The imaging apparatus according to claim 26, wherein a gap between the light-emitting surface of the first optical member and the incident surface of the second optical member are sealed.
